(19) United States
(12) Patent Application Publication
(10) Pub. No.: US 2006/0227231 A1
(43) Pub. Date: Oct. 12, 2006

(54) Photoelectric conversion device and electronic equipment

(75) Inventor: Norikazu Okada, Kashihara-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/397,633

(22) Filed: Apr. 5, 2006

(30) Foreign Application Priority Data
Apr. 6, 2005 (JP) 2005-109739

(51) Int. Cl. H04N 3/14

(52) U.S. Cl. 348/294; 348/301

(57) ABSTRACT

The photoelectric conversion device has a current amplifier 2 that amplifies a photodetection current outputted from a photodiode 1. Therefore, even when the photodetection current is feeble or the signal-to-noise ratio of the photodetection current is low, the signal amplitude of the output current inputted to the logarithmic compression part 3 can be secured. Moreover, the signal-to-noise ratio of the output signal can be secured even when the signal-to-noise ratio of the input light is low.

### CROSS-REFERENCE TO RELATED APPLICATIONS

The present non-provisional application claims priority based on JP 2005-109739 applied for patent in Japan on Apr. 6, 2005 under U.S. Code, Volume 35, Chapter 119(a). The disclosure of the application is fully incorporated herein by reference.

### BACKGROUND OF THE INVENTION

The present invention relates to a photoelectric conversion device and electronic equipment provided with the device and relates to a photoelectric conversion device, which is adopted, as one example, for an optical encoder that detects the position, moving speed, moving direction and so on of a mobile object by means of a photodetector and suitable for use in printing apparatuses such as copying machines and printers, FA (Factory Automation) equipment and so on.

Conventionally, as shown in FIG. 10, a photosensor that outputs an output voltage Vout by logarithmically converting a photocurrent corresponding to the incident light intensity of light incident on a photodiode 101 by means of a logarithmic conversion circuit 102 is known (JP S61-61457 A).

Moreover, a photoelectric conversion device that logarithmically compresses the output signal of a photodiode by an n-MOS transistor is known as another prior art (JP 2001-215550 A).

According to the conventional photosensor and the optical sensor that adopts the photoelectric conversion device, information of faint light has been able to be obtained by logarithmically compressing the photocurrent from the photodiode.

However, when the signal-to-noise ratio of the input light to the photodiode is insufficient, there is a problem that a satisfactory signal-to-noise ratio cannot be secured after logarithmically compressing the photocurrent, variation factors such as the offset and so on of the logarithmic compression circuit cannot be ignored, and a satisfactory amplification characteristic cannot be secured.

### SUMMARY OF THE INVENTION

An object of the present invention is to provide a photoelectric conversion device capable of securing the signal-to-noise ratio of the output signal even when the signal-to-noise ratio of the input light is low.

In order to achieve the above object, there is provided a photoelectric conversion device comprising:

a photoelectric conversion element;

a current amplification part that amplifies a photodetection current outputted from the photoelectric conversion element; and

a logarithmic compression part that receives an output current of the current amplification part as an input thereto, logarithmically compresses the inputted current and outputs a logarithmically compressed signal.

According to the photoelectric conversion device, by virtue of the provision of the current amplification part that amplifies the photodetection current outputted from the photoelectric conversion element, the signal amplitude of the output current inputted to the logarithmic compression part can be secured even when the photodetection current is feeble and the signal-to-noise ratio of the photodetection current is low. Therefore, according to the present invention, the signal-to-noise ratio of the output signal can be secured even when the signal-to-noise ratio of the input light is low.

In one embodiment of the invention the logarithmic compression part has a current compensation circuit to which an adjusting current is inputted.

According to the photoelectric conversion device of the embodiment, the current compensation circuit inputs the adjusting current to the logarithmic compression part. Therefore, by making compensation for the leakage current and so on in the logarithmic compression part, the logarithmically compressed signal of a little variation can be outputted from the logarithmic compression part.

In one embodiment of the invention, the photoelectric conversion device further comprises:

a first photoelectric conversion element;

a second photoelectric conversion element;

a first current amplification part that amplifies a first photodetection current outputted from the first photoelectric conversion element;

a second current amplification part that amplifies a second photodetection current outputted from the second photoelectric conversion element;

a first logarithmic compression part that logarithmically compresses a first output current outputted from the first current amplification part and outputs a first logarithmically compressed signal;

a second logarithmic compression part that logarithmically compresses a second output current outputted from the second current amplification part and outputs a second logarithmically compressed signal; and

a differential amplifier to which the first logarithmically compressed signal and the second logarithmically compressed signal are inputted.

According to the photoelectric conversion device of the embodiment, by amplifying the first and second photodetection currents outputted from the first and second photoelectric conversion elements in the first and second current amplification parts and logarithmically compressing the first and second output currents outputted from the first and second current amplification parts, the first and second logarithmically compressed signals are outputted. The first and second logarithmically compressed signals are inputted to the differential amplifier, and the signals are amplified. Therefore, a logarithmically compressed signal of a large signal-to-noise ratio is obtained.

In one embodiment of the invention, the photoelectric conversion device further comprises:

a first photoelectric conversion element;

a second photoelectric conversion element;

a first current amplification part that amplifies a first photodetection current outputted from the first photoelectric conversion element; and

a second current amplification part that amplifies a second photodetection current outputted from the second photoelectric conversion element, wherein

the logarithmic compression part

receives a first output current from the first current amplification part and a second output current from the second current amplification part as inputs thereto and outputs a logarithmically compressed signal by logarithmically compressing a current difference between the first output current and the second output current.

According to the photoelectric conversion device of the embodiment, the first and second photodetection currents outputted from the first and second photoelectric conversion elements are amplified in the first and second current amplification parts. Then, the logarithmic compression part outputs the logarithmically compressed signal by logarithmically compressing a current difference between the first output current outputted from the first current amplification part and the second output current outputted from the second current amplification part. Therefore, when the two input light rays inputted to the first and second photoelectric conversion elements are mutually inverted signals, the signal amplitude of the logarithmically compressed signal can be further increased by amplifying the current difference between the first and second output currents being mutually inverted.

In one embodiment of the invention, the logarithmic compression part comprises:

a diode that logarithmically compresses an output current of the current amplification part; and

a resistor connected in parallel with the diode.

According to the photoelectric conversion device of the embodiment, by connecting the resistor in parallel with the diode for logarithmic compression in the logarithmic compression part, it becomes possible to linearly amplify the output current obtained by amplifying the photodetection current due to the faint light inputted to the photoelectric conversion element.

In one embodiment of the invention, an electronic equipment comprises the above photoelectric conversion device.

According to the electronic equipment, the electronic equipment provided with a photoelectric conversion device of high sensitivity capable of securing the prescribed signal-to-noise ratio of the output signal with respect to the input light of a low signal-to-noise ratio is provided.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram showing a first embodiment of the photoelectric conversion device of the present invention;

FIG. 2 is a characteristic graph showing the logarithmic compression characteristic of the first embodiment;

FIG. 3 is a block diagram showing a second embodiment of the photoelectric conversion device of the present invention;

FIG. 4 is a circuit diagram showing a third embodiment of the photoelectric conversion device of the present invention;

FIG. 5 is a circuit diagram showing a fourth embodiment of the photoelectric conversion device of the present invention;

FIG. 6 is a circuit diagram showing a fifth embodiment of the photoelectric conversion device of the present invention;

FIG. 7A is a characteristic graph showing the relations between the photodetection current and the photodetection voltage indicated by a characteristic curve Z1 when the current compensation circuit is not provided although the current amplification part is provided and a characteristic curve Z2 when the current compensation circuit is provided although the current amplification part is not provided;

FIG. 7B is a characteristic graph showing the relations between the photodetection current and the photodetection voltage indicated by a characteristic Z3 when the current compensation is large and a characteristic Z4 when the current compensation is small in the case where the current amplification part is not provided although the logarithmic compression part and the current compensation circuit are provided;

FIG. 8 is a circuit diagram showing a sixth embodiment of the photoelectric conversion device of the present invention;

FIG. 9 is a circuit diagram showing a seventh embodiment of the photoelectric conversion device of the present invention; and

FIG. 10 is a block diagram of a conventional photoelectric conversion device.

### DETAILED DESCRIPTION OF THE INVENTION

The present invention will be described in detail below by the embodiments shown in the drawings.

### First Embodiment

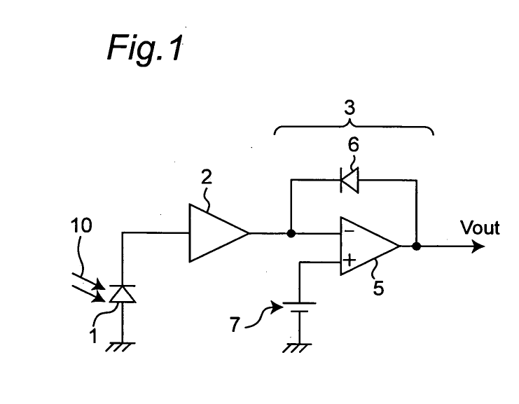

The first embodiment of the photoelectric conversion device of the present invention is shown in FIG. 1. The first embodiment includes a photodiode 1 as a photoelectric conversion element, a current amplifier 2 that amplifies a photodetection current outputted from the photodiode 1, and a logarithmic compression part 3 that outputs an output voltage Vout as a logarithmically compressed signal by logarithmically compressing the output current of the current amplifier 2.

The logarithmic compression part 3 has an operational amplifier 5 and a diode 6. A prescribed dc power source 7 is connected to the in-phase input terminal of the operational amplifier 5, and the output terminal of the current amplifier 2 is connected to the anti-phase input terminal. Moreover, the diode 6 is connected between the output terminal and the anti-phase input terminal of the operational amplifier 5.

In the photoelectric conversion device, when light 10 is incident on the photodiode 1, a photodetection current corresponding to the intensity of the incident light flows through the photodiode 1. The photodetection current is amplified by the current amplifier 2. The amplified photodetection current is inputted as an output current from the current amplifier 2 to the logarithmic compression part 3. The logarithmic compression part 3 outputs an output voltage Vout as the logarithmically compressed signal by logarithmically compressing the output current.

According to the photoelectric conversion device of the first embodiment, by virtue of the provision of the current amplifier 2 that amplifies the photodetection current outputted from the photodiode 1, the signal amplitude of the output current inputted to the logarithmic compression part 3 can be secured even when the photodetection current is feeble or when the signal-to-noise ratio of the photodetection current is low. Therefore, according to the embodiment, the signal-to-noise ratio of the output signal can be secured even when the signal-to-noise ratio of the incident light is low.

The current amplifier 2 should preferably have a simple construction so that the amplifier is not influenced by the circuit variation and the like.

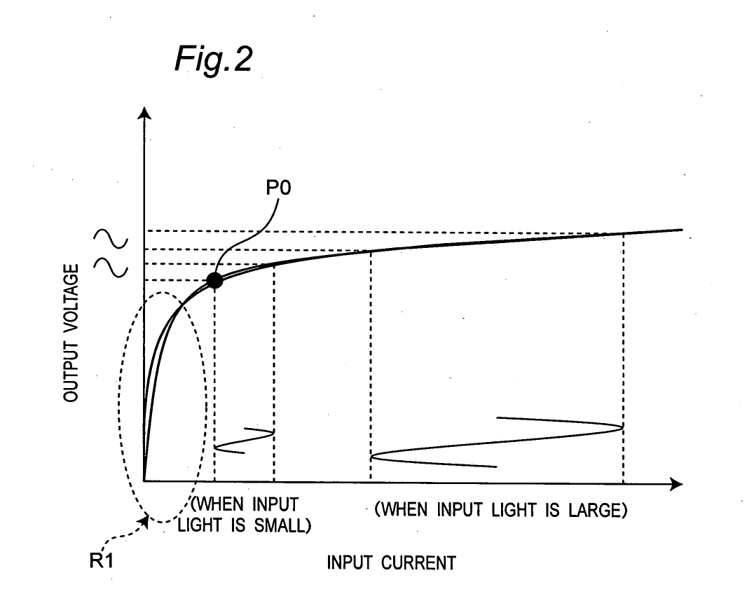

The characteristic of the relation between the input current inputted to the logarithmic compression part 3 and the output voltage Vout of the logarithmic compression part 3 is shown in FIG. 2. In the absence of the current amplifier 2, the input current is the photodetection current of the photodiode 1. With regard to the characteristic, a point P0 indicates the optimum values of the input current and the output voltage Vout when there is no incident light. In FIG. 2, as indicated by a region R1 enclosed by the dashed line, the diode characteristic is varied by a leakage current or the like when the input current is a feeble current.

In contrast to this, by virtue of the provision of the current amplifier 2, the current inputted to the logarithmic compression part 3 is increased, and the characteristic variation of the logarithmic compression part 3 can be suppressed when the photodetection current is feeble in the present embodiment.

### Second Embodiment

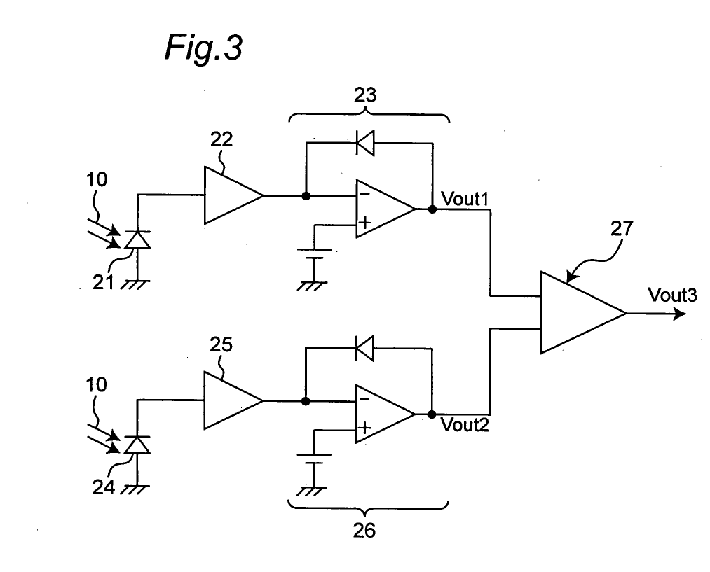

Next, the second embodiment of the photoelectric conversion device of the present invention is shown in FIG. 3. The second embodiment has a first photodiode 21 as a first photoelectric conversion element, a first current amplifier 22 that amplifies a first photodetection current outputted from the first photodiode 21, and a first logarithmic compression part 23 that outputs a first output voltage Vout1 as a first logarithmically compressed signal by logarithmically compressing a first output current of the first current amplifier 22. The first logarithmic compression part 23 has a construction similar to that of the logarithmic compression part 3 of the first embodiment.

Moreover, the second embodiment has a second photodiode 24 as a second photoelectric conversion element, a second current amplifier 25 that amplifies a second photodetection current outputted from the second photodiode 24, and a second logarithmic compression part 26 that outputs a second output voltage Vout2 as a second logarithmically compressed signal by logarithmically compressing a second output current of the second current amplifier 25. The second logarithmic compression part 26 has a construction similar to that of the logarithmic compression part 3 of the first embodiment.

Moreover, the second embodiment has a differential amplifier 27 to which the first output voltage Vout1 outputted from the first logarithmic compression part 23 and the second output voltage Vout2 outputted from the second logarithmic compression part 26 are inputted. The differential amplifier 27 amplifies a difference between the first output voltage Vout1 and the second output voltage Vout2 and outputs an output voltage Vout3.

According to the second embodiment, by amplifying the first and second photodetection currents by the first and second current amplifiers 22 and 25 and logarithmically compressing the first and second output currents outputted from the first and second current amplifiers 22 and 25 in the first and second logarithmic compression parts 23 and 26, the first and second logarithmically compressed signals are outputted. The first and second logarithmically compressed signals are inputted to the differential amplifier 27, and the signal is amplified. Therefore, a logarithmically compressed signal of a large signal-to-noise ratio is obtained.

### Third Embodiment

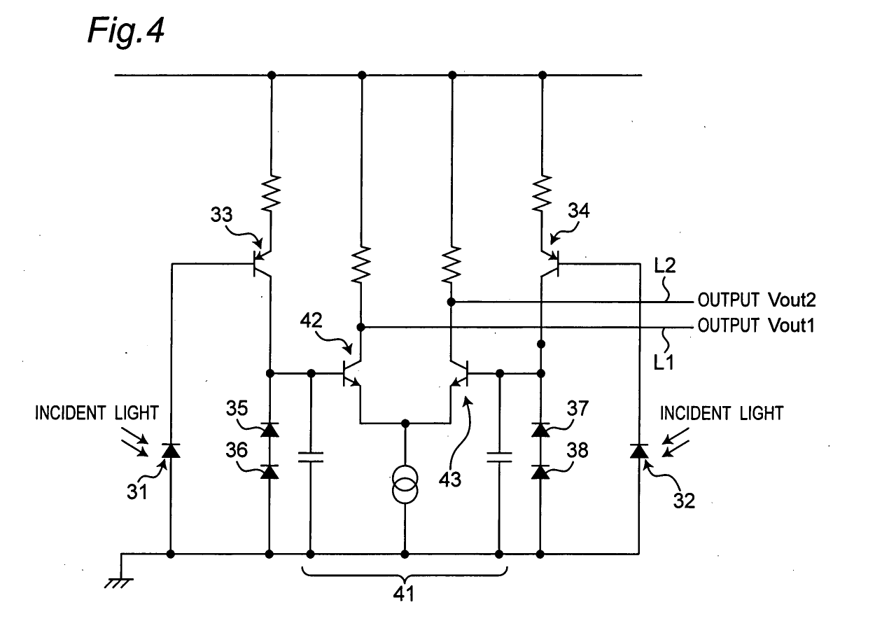

Next, the third embodiment of the photoelectric conversion device of the present invention is shown in FIG. 4. The photoelectric conversion device of the third embodiment has a mobile object that has a slit between the light-emitting element and the photodetector and serves as a photodetection circuit for an optical encoder that reads the slit moving speed of the mobile object.

The photoelectric conversion device of the third embodiment has a first photodiode 31 as a first photoelectric conversion element (photodetector) and a second photodiode 32 as a second photoelectric conversion element (photodetector). Moreover, the third embodiment has a first pnp bipolar transistor 33 as a first current amplification part that amplifies a first photodetection current outputted from the first photodiode 31 by a current amplification factor hfe. Moreover, the third embodiment has a second pnp bipolar transistor 34 as a second current amplification part that amplifies a second photodetection current outputted from the second photodiode 32 by a current amplification factor hfe.

Moreover, the third embodiment has diodes 35 and 36 that logarithmically compress a first output current outputted from the first pnp bipolar transistor 33. The diodes 35 and 36 are connected in series. The two diodes 35 and 36 connected in series constitute a first logarithmic compression part. Moreover, the third embodiment has diodes 37 and 38 that logarithmically compress a second output current outputted from the second pnp bipolar transistor 34. The two diodes 37 and 38 are connected in series. The two diodes 37 and 38 connected in series constitute a second logarithmic compression part.

Moreover, the third embodiment has a differential amplifier 41 to which the first logarithmically compressed signal outputted from the first logarithmic compression part and the second logarithmically compressed signal outputted from the second logarithmic compression part are inputted. The differential amplifier 41 has two npn bipolar transistors 42 and 43. The first logarithmically compressed signal is inputted to the base of the transistor 42, and the second logarithmically compressed signal is inputted to the base of the transistor 43. The differential amplifier 41 outputs the first output signal Vout1 to a first output line L1 connected to the collector of the transistor 42, and the second output signal Vout2 is outputted to a second output line L2 connected to the collector of the transistor 43.

According to the third embodiment, the first and second logarithmically compressed signals are inputted to the differential amplifier 41, and the signal is amplified, obtaining a logarithmically compressed signal of a large signal-to-noise ratio.

Although the first and second logarithmic compression parts are constructed respectively of two diodes in the third embodiment, it is desirable to provide each logarithmic compression part by connecting in series a largest possible number of, or not less than three diodes. This is because the amplitudes of the logarithmically compressed signals outputted from each logarithmic compression part are added up by connecting a plurality of diodes in series and thus a logarithmically compressed signal of larger amplitude is obtained.

### Fourth Embodiment

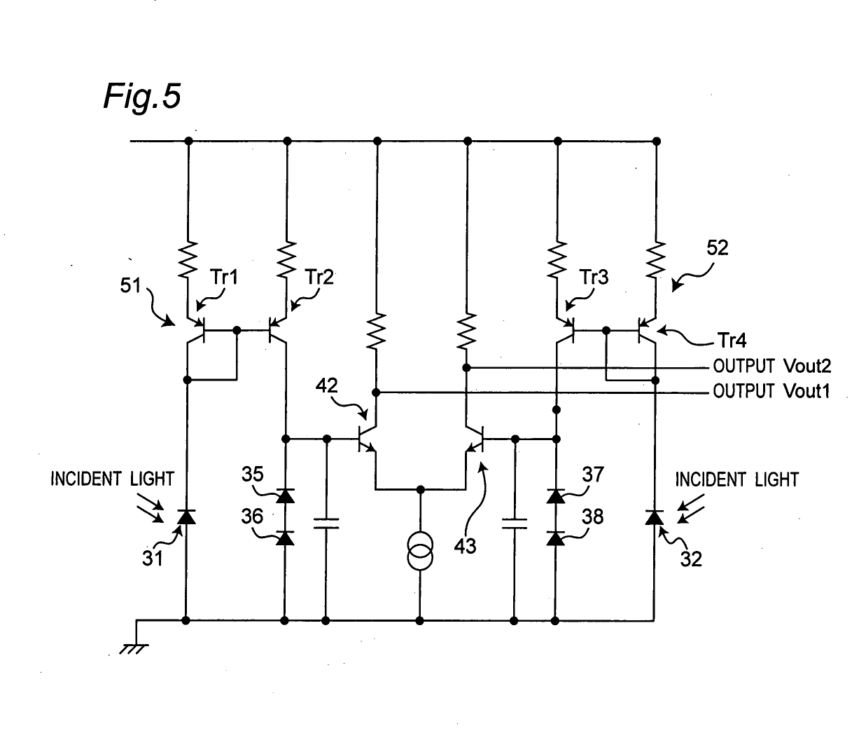

Next, the fourth embodiment as a modification example of the third embodiment is shown in FIG. 5. The fourth embodiment differs from the third embodiment in that a first current mirror circuit 51 is provided as a first current amplification part in place of the first pnp bipolar transistor 33 of FIG. 4. Moreover, the fourth embodiment differs from the third embodiment in that a second current mirror circuit 52 is provided as a second current amplification part in place of the second pnp bipolar transistor 34 of FIG. 4.

In the fourth embodiment, the current amplification factor of the current mirror circuit 51 can be adjusted by adjusting the number of transistors Tr2 out of transistors Tr1 and Tr2 that constitute the current mirror circuit 51. Moreover, the current amplification factor of the current mirror circuit 52 can be adjusted by adjusting the number of transistors Tr3 out of the transistors Tr3 and Tr4 that constitute the current mirror circuit 52.

### Fifth Embodiment

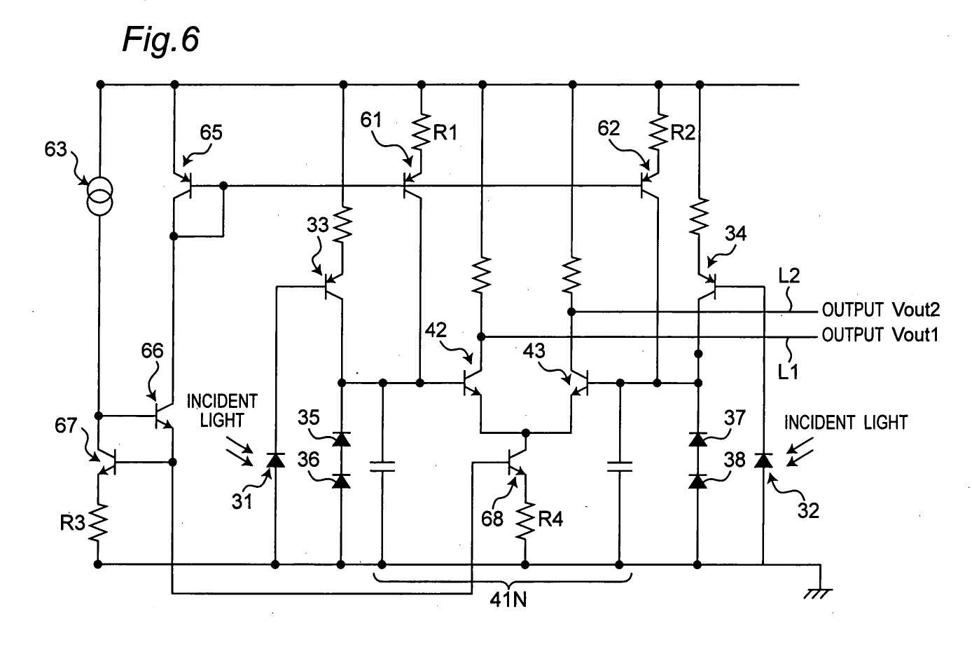

Next, the fifth embodiment of the photoelectric conversion device of the present invention is shown in FIG. 6. The fifth embodiment differs from the third embodiment in that a current compensation circuit for adding an adjusting current to output currents outputted from the transistors 33 and 34 that constitute the current amplification part of FIG. 4 for inputting to the logarithmic compression part. Therefore, the points different from the third embodiment are described in the fifth embodiment.

The current compensation circuit has a bipolar transistor 61 whose collector is connected to the base of the bipolar transistor 42 owned by a differential amplifier 41N and a bipolar transistor 62 whose collector is connected to the base of the bipolar transistor 43 owned by the differential amplifier 41N. Resistors R1 and R2 are connected between the emitters of the transistors 61 and 62 and a current source 63. Moreover, the bases of the transistors 61 and 62 are connected to the base of a bipolar transistor 65. The base of the bipolar transistor 65 is connected to its collector. The collector of the bipolar transistor 65 is connected to the collector of a bipolar transistor 66, and the base of the bipolar transistor 66 is connected to the current source 63.

The emitter of the bipolar transistor 66 is connected to the base of the bipolar transistor 67, and the collector of the bipolar transistor 67 is connected to the current source 63. The emitter of the bipolar transistor 67 is connected to the emitter of a bipolar transistor 68 via a resistor R3 and a resistor R4. Moreover, the base of the bipolar transistor 68 is connected to the base of the bipolar transistor 67.

According to the current compensation circuit, by adjusting so that the output currents from the transistors 61 and 62 become proportional to the amplification factor of the differential amplifier 41N utilizing the base current of the current mirror circuit of the transistors 67 and 68, currents inputted to the first and second logarithmic compression parts (diodes 35 and 36 and diodes 37 and 38) are adjusted. That is, the current compensation circuit inputs the adjusting current proportional to the amplification factor of the differential amplifier 41N to the diodes 35 and 36 that constitute the first logarithmic compression part. Therefore, the adjusting current is inputted to the diodes 35 and 36 in addition to the output current from the transistor 33 as a first current amplification part.

Moreover, the current compensation circuit inputs the adjusting current proportional to the amplification factor of the differential amplifier 41N to the diodes 37 and 38 that constitute the second logarithmic compression part. Therefore, the adjusting current is inputted to the diodes 37 and 38 in addition to the output current from the transistor 34 as a second current amplification part.

With the arrangement, it becomes possible to use the diodes 35 through 38 that constitute the first and second logarithmic compression parts at the optimum values of the diode characteristics avoiding the region of large characteristic variations such as the region R1 of FIG. 2. Therefore, a photoelectric conversion device of an excellent signal-to-noise ratio can be provided.

In the fifth embodiment, the currents to the first and second logarithmic compression parts can be adjusted by adjusting the number of transistors 65 that constitute the current compensation circuit and the resistance values of the resistors R1 and R2.

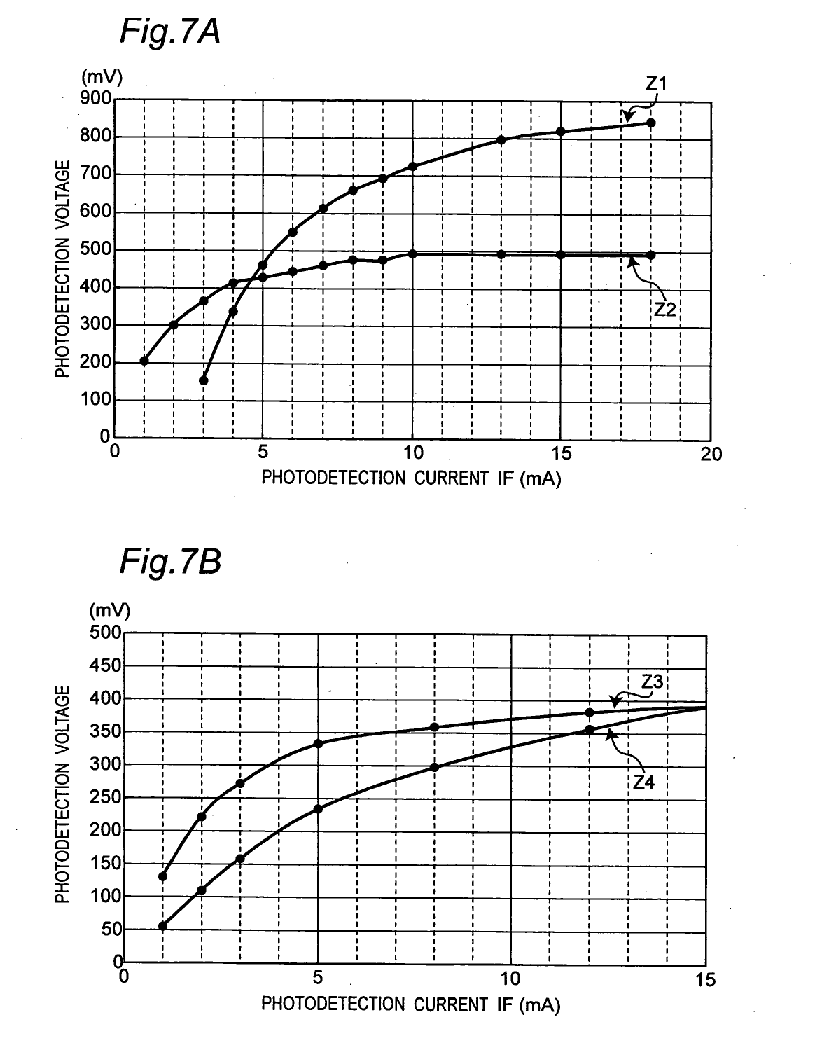

In this case, the relation between a photodetection current IF and the photodetection voltage of the logarithmically compressed signal outputted from the logarithmic compression part in the third embodiment in which no current compensation circuit output is provided although the current amplification part is provided is indicated by the characteristic curve Z1 in FIG. 7A. Moreover, the characteristic curve Z2 of FIG. 7A represents the characteristic when no current amplification part is provided (the current compensation circuit is provided) in the fifth embodiment. Referring to the characteristic curves Z1 and Z2, it can be understood that the effect of improving the signal-to-noise ratio by increasing the photodetection voltage is produced more largely by the current amplification part than by the current compensation circuit when the photodetection current IF is not smaller than about 5 mA. On the other hand, conversely, the effect of improving the signal-to-noise ratio is produced more largely by the current compensation circuit than the effect of improving the photodetection voltage of the current amplification part when the photodetection current IF is smaller than about 5 mA.

Moreover, FIG. 7B shows (photodetection current IF—signal-to-noise ratio) characteristic curves Z3 and Z4 of the photoelectric conversion device in the case (Comparative Example 1) where no current amplification part is provided although the logarithmic compression part and the current compensation circuit are provided as in the fifth embodiment. The characteristic curve Z3 is in the case where the current compensation (i.e., adjusting current) due to the current compensation circuit is large, and the characteristic curve Z4 is in the case where the current compensation (i.e., adjusting current) due to the current compensation circuit is small.

If the characteristics Z3 and Z4 are compared with each other, it can be understood that the signal-to-noise ratio can be improved by increasing the photodetection voltage with faint light of a small photodetection current by increasing the current compensation of the current compensation circuit.

Therefore, by providing the current compensation circuit for the third embodiment in which no current compensation circuit is provided although the current amplification part is provided, the signal-to-noise ratio in the region of faint light indicated by the characteristic curve Z1 of FIG. 7A can be improved.

### Sixth Embodiment

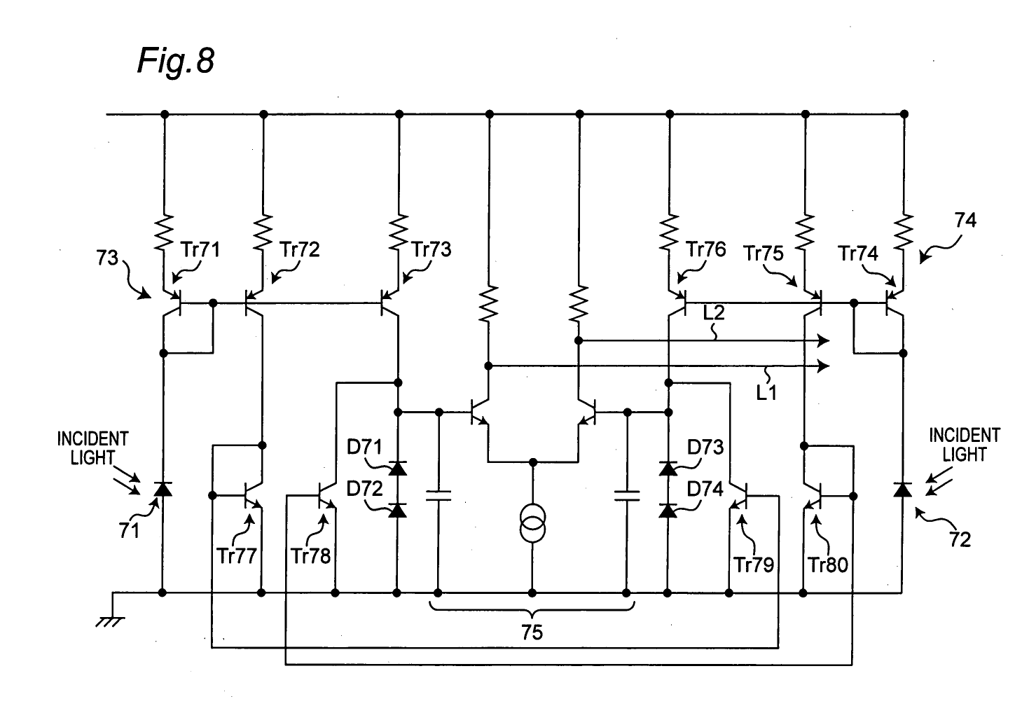

Next, the sixth embodiment of the photoelectric conversion device of the present invention is shown in FIG. 8. The sixth embodiment has a first photodiode 71 as a first photoelectric conversion element and a second photodiode 72 as a second photoelectric conversion element.

In the sixth embodiment, input light incident on the first photodiode 71 and input light incident on the second photodiode 72 are mutually inverted signals.

The sixth embodiment has a first current mirror circuit 73 as a first current amplification part that amplifies a first photodetection current outputted from the first photodiode 71. Moreover, the sixth embodiment has a second current mirror circuit 74 as a second current amplification part that amplifies a second photodetection current outputted from the second photodiode 72.

The first current mirror circuit 73 has transistors Tr71, Tr72 and Tr73, and the second current mirror circuit 74 has transistors Tr74, Tr75 and Tr76.

Moreover, the sixth embodiment has a differential amplifier 75, diodes D71 and D72, diodes D73 and D74, and transistors Tr77, Tr78, Tr79 and Tr80. The diodes D71 through D74 and the transistors Tr77 through 80 constitute a logarithmic compression part.

In the sixth embodiment, the first current mirror circuit 73 amplifies a first photodetection current outputted from the first photodiode 71 and outputs the resulting current from the transistor Tr73 to the diodes D71 and D72. On the other hand, the second current mirror circuit 74 amplifies a second photodetection current outputted from the second photodiode 72 and outputs the resulting current from the transistor Tr76 to the diodes D73 and D74.

A current from the transistor Tr75 of the second current mirror circuit 74 flows through the transistor Tr80, and a current equal to the current that flows through the transistor Tr80 flows through the transistor Tr78. As a result, a current obtained by subtracting the current (current obtained by amplifying the second photodetection current) coming from the transistor Tr75 of the second current mirror circuit 74 from the current (current obtained by amplifying the first photodetection current) coming from the transistor Tr73 of the first current mirror circuit 73 flows through the diodes D71 and D72.

On the other hand, a current from the transistor Tr72 of the first current mirror circuit 73 flows through the transistor Tr77, and a current equal to the current that flows through the transistor Tr77 flows through the transistor Tr79. As a result, a current obtained by subtracting the current (current obtained by amplifying the first photodetection current) coming from the transistor Tr72 of the first current mirror circuit 73 from the current (current obtained by amplifying the second photodetection current) coming from the transistor Tr76 of the second current mirror circuit 74 flows through the diodes D73 and D74.

Therefore, in the sixth embodiment, the current difference between the first photodetection current that serves as the inverted signal and the second photodetection current are logarithmically compressed. Therefore, the signal of the increased amplitude is to be logarithmically compressed, and the signal-to-noise ratio can be improved.

### Seventh Embodiment

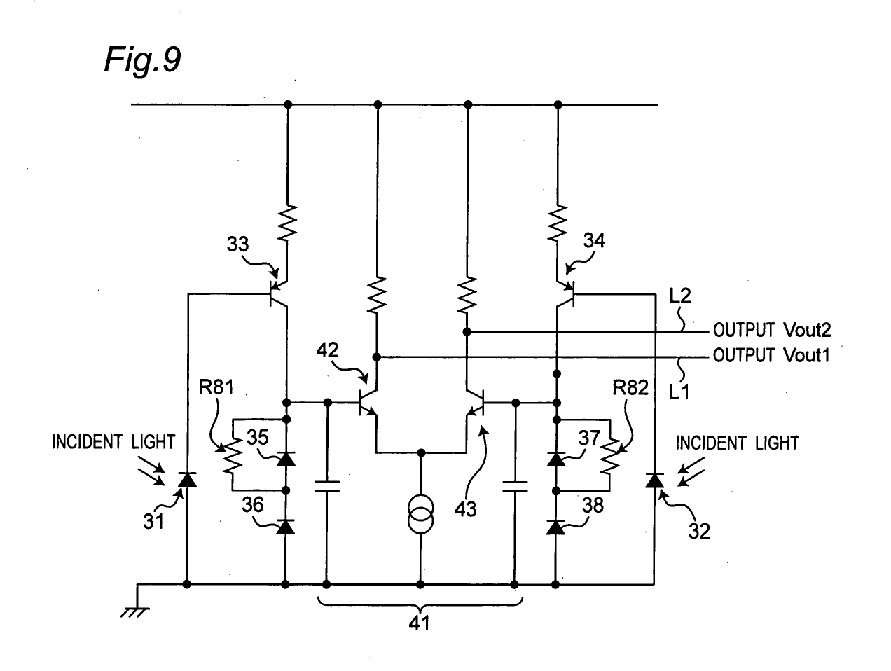

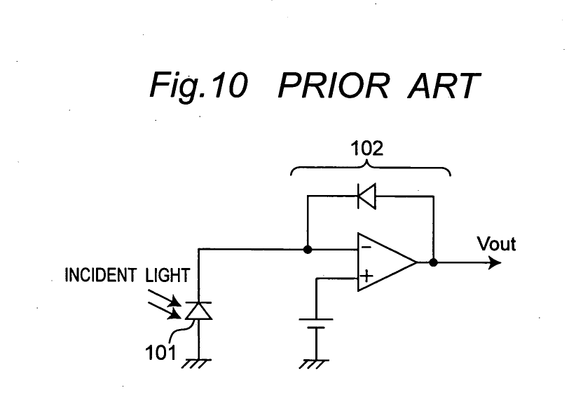

Next, the seventh embodiment of the photoelectric conversion device of the present invention is shown in FIG. 9. The seventh embodiment is a modification example of the third embodiment of FIG. 4 and differs from the third embodiment only in that a resistor R81 connected in parallel with a diode 35 that constitutes a first logarithmic compression part and a resistor R82 connected in parallel with a diode 37 that constitutes a second logarithmic compression part are provided.

According to the seventh embodiment, by providing the first and second logarithmic compression parts with the resistors R81 and R82 connected in parallel with the diodes 35 and 37, when the input light to the first and second photodiodes 31 and 32 is faint light, an output current obtained by amplifying the photodetection current due to the faint light can be taken out as a voltage signal with high resolution and inputted to the differential amplifier 41.

It is desirable to connect the resistors R81 and R82 in parallel with the diodes 35 and 37. It is because the output voltage of the logarithmic compression part rises in proportion to the increase in the quantity of photodetection light when the resistors are connected in series with the diodes 35 and 37, and this disadvantageously limits the range of use and reduces the logarithmic compression effect. Moreover, since the photodetection current is required to be converted into a voltage only when the quantity of photodetection light is small, the resistors R81 and R82 of the logarithmic compression parts are required to be connected in parallel with the diodes 35 and 37 of one stage as shown in FIG. 9. With this arrangement, the currents flowing through the resistors R81 and R82 are limited, and this is effective for the logarithmic compression when the quantity of photodetection light is large.

The photoelectric conversion devices of the first through seventh embodiments are suitable for constituting an optical encoder and suitable for use in copying machines, printing apparatuses such as printers and FA equipment.

Although the present invention has been described as above, it is obvious that the present invention can be modified by a variety of methods. Such modifications are not regarded as departing from the spirit and scope of the present invention, and it is appreciated that improvements apparent to those skilled in the art are fully included within the scope of the following claims.

1. A photoelectric conversion device comprising:
a photoelectric conversion element;
a current amplification part that amplifies a photodetection current outputted from the photoelectric conversion element; and
a logarithmic compression part that receives an output current of the current amplification part as an input thereto, logarithmically compresses the inputted current and outputs a logarithmically compressed signal.

2. The photoelectric conversion device as claimed in claim 1, wherein
the logarithmic compression part has a current compensation circuit to which an adjusting current is inputted.

3. The photoelectric conversion device as claimed in claim 1, comprising:
a first photoelectric conversion element;
a second photoelectric conversion element;
a first current amplification part that amplifies a first photodetection current outputted from the first photoelectric conversion element;
a second current amplification part that amplifies a second photodetection current outputted from the second photoelectric conversion element;
a first logarithmic compression part that logarithmically compresses a first output current outputted from the first current amplification part and outputs a first logarithmically compressed signal;
a second logarithmic compression part that logarithmically compresses a second output current outputted from the second current amplification part and outputs a second logarithmically compressed signal; and
a differential amplifier to which the first logarithmically compressed signal and the second logarithmically compressed signal are inputted.

4. The photoelectric conversion device as claimed in claim 1, comprising:
a first photoelectric conversion element;
a second photoelectric conversion element;
a first current amplification part that amplifies a first photodetection current outputted from the first photoelectric conversion element; and
a second current amplification part that amplifies a second photodetection current outputted from the second photoelectric conversion element, wherein
the logarithmic compression part
receives a first output current from the first current amplification part and a second output current from the second current amplification part as inputs thereto and outputs a logarithmically compressed signal by logarithmically compressing a current difference between the first output current and the second output current.

5. The photoelectric conversion device as claimed in claim 1, wherein
the logarithmic compression part comprises:
a diode that logarithmically compresses an output current of the current amplification part; and
a resistor connected in parallel with the diode.

6. Electronic equipment comprising the photoelectric conversion device claimed in claim 1.

7. Electronic equipment comprising the photoelectric conversion device claimed in claim 2.

8. Electronic equipment comprising the photoelectric conversion device claimed in claim 3.

9. Electronic equipment comprising the photoelectric conversion device claimed in claim 4.
